(19) United States
(12) Patent Application Publication
(10) Pub. No.: US 2007/0039169 A1
(43) Pub. Date: Feb. 22, 2007

(54) Apparatus for producing core packets

(75) Inventors: Jurgen Beyerer, Dielhelm (DE); Gelson Montero, Oftersheim (DE); Reiner Rommel, Bruhl (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Hottinger Maschinenbau GmbH

(21) Appl. No.: 11/347,952

(22) Filed: Feb. 6, 2006

Related U.S. Application Data
(63) Continuation of application No. PCT/DE04/00599, filed on Mar. 23, 2004.

(30) Foreign Application Priority Data
Aug. 6, 2003 (DE) 103 36 395.5

(51) Int. Cl. B21B 1/46; B23P 21/00

(52) U.S. Cl. 29/771; 29/711; 29/527.3

(57) ABSTRACT

An apparatus for producing core packets used in the foundry industry wherein a plurality of tools for shooting cores are arranged on a rotary table so that the tools can be serially moved between a shooting station and a removal station where the cores are removed and assembled to form core packets on an assembly line. A plurality of shooting caps are provided, each comprising a sand store and a shooting plate, and the shooting caps are mounted on a second rotary table so that they can be selectively moved to the shooting station in coordination with the movement of the tools.

### CROSS REFERENCE TO RELATED APPLICATION

The present application is a continuation of international application PCT/DE2004/000599, filed 23 Mar., 2004, and which designates the U.S. The disclosure of the referenced application is incorporated herein by reference.

### BACKGROUND OF THE INVENTION

The invention relates to an apparatus for producing core packets used especially for casting engine blocks and cylinder heads, and of the type comprising a shooting station in which individual cores are shot, and a removal station in which the shot cores are removed and are transferred onto an assembly line for packet assembly, and wherein a shooting cap comprising a sand store and a shooting plate can be associated together with a shooting head to a preferably two-part tool at the shooting station.

The invention refers, in general, to the production of cores, which are completed to form a core packet. The core packet is used as a mold in foundry technology. For the casting of molding pieces, any type of foundry cores or foundry molds are produced mostly from two parts, brought together and joined to one another to form a casting mold and/or a core packet or mold packet. These core packets are then filled with molten metal for the production of, for example, a metallic tool, wherein in series production, the core packets to be filled with molten metal pass successively through the production line.

For decades core and mask shooting machines for the production of the cores to be joined to one another have been known from practical experience. Reference is made here, only by way of example, to DE 31 48 461 C1, which discloses a category-defining core and mask shooting machine.

In the known core and mask shooting machine, a double tool is pivotable about a horizontal axis, while a shooting cap together with a shooting head is pivotable about a vertical axis and can be coupled to the tool. The removal station corresponds to the shooting station, in which the tool that is vertically divided there is opened and the shot core is removed for further processing.

The core and mask shooting machines known from DE 31 48 461 C1 is suited at most for shooting two different cores and is therefore not suitable for the production of a complete core packet consisting of several cores for the casting of engine blocks and cylinder heads. The known core and mask shooting machine is at most suitable for the production of one and the same core, wherein the duplicity of the tool can be used in order to exchange the tool without having to stop the production process, in that namely the worn out and/or soiled tool is exchanged for another by the horizontal pivoting. In any case, an automatic production of complete core packets is not possible using the known core and mask shooting machine.

The object of the present invention is to provide an apparatus for producing core packets especially used for the casting of engine blocks and cylinder heads so as to enable an automatic production of complete core packets with the least possible required space.

### SUMMARY OF THE INVENTION

The above and other objects and advantages of the invention are achieved by a core shooting apparatus wherein several tools for shooting different cores are arranged on a rotary table. By rotating the rotary table, the tools can be brought one after the other into the shooting station and from the shooting station together with the shot cores into the removal station.

It has been found according to the invention that several tools for the shooting of different cores can be combined in the smallest space by arranging the tools on a rotary table. The tools can be different tools for shooting different cores or even tools for shooting the same cores, according to requirements. By rotating the rotary table, the tools are brought one after the other into the shooting station and from the shooting station together with the shot cores into the removal station. In the removal station the cores are removed using a manipulator and are fed to the core packet assembly.

Thus a single shooting station is provided in the manner according to the invention. The rotary table is equipped with tools corresponding to the number of the required cores, so that the tools are fed using the rotary table to the shooting station in the order of the requirement. The shot cores are accordingly fed together with the tool in the predetermined order to the removal station so that the cores are removed there in succession—again corresponding to requirements. An automatic packet assembly of the cores into a core packet is thus possible.

At this point it must be observed that the size of the rotary table can be predetermined corresponding to requirements. Tools of varying quantities can accordingly be arranged on the rotary table preferably equidistantly from one another.

In a specific embodiment, the rotary table is equipped in the manner of a carousel with arms carrying the tools, wherein the arms extend outwardly in a star-shaped arrangement. Further, the arrangement of six tools on the rotary table in question is a six station star handle having six different tools or even the same tools, at least in part.

The tools together with tool carriers and the frames holding the tool carriers may be arranged on the rotary table. For opening the tool, special lifting devices are provided, which are assigned preferably to the tool carrier. Furthermore, a lower ejection device for ejecting the core can be assigned to the tool carrier and/or to the lifting device, though such an arrangement is not a strict requirement.

The lifting devices assigned to the tools on the rotary table operate hydraulically or pneumatically. In any case, the lifting devices are devices, which can move together with the tools, namely due to the fixed assignment of the lifting equipment to the respective tool.

In the shooting station, each core is shot with each of the tools located there. For this purpose the shooting head required for shooting is stationarily arranged at the shooting station. The tool is pressed with the individual shooting plate and the sand store against the shooting head, so that the shooting process can take place under the influence of compressed air.

The sand bunker and the shooting caps and/or the shooting plate attached thereto can be used in a water-cooled design. For this purpose the cooling water inlet and/or outlet are preferably automatically docked on the rotary table and in the shooting station. By this measure the temperature sensitive molding sand can be held in a good shootable state, namely by the thus implemented cooling system.

In order that the so-called cold box core sand can be processed, especially in summer over a longer period of time, the sand stores are to be equipped with a lid. Using a special device, the lid is removed during the filling process and in the shooting station and is thereafter put back on the sand store. What is achieved in doing so is that the solvents in the molding sand cannot escape that quickly and the sand does not dry up. In addition, an unintended pre-reaction of the molding sand is prevented. If necessary, the hollow space in the sand store could be filled with an inert gas in order to prevent a reaction by all means.

It is basically possible to arrange the tools together with a lifting device for lifting and pressing the tool against the shooting head on the rotary table. In a corresponding design form, it is feasible that the lifting device used for opening the tool can also be used for bringing the tool into the shooting position. However, in a particularly advantageous manner a special lifting device used for lifting and pressing the tool against the shooting head is provided, said lifting device being arranged stationarily in the shooting station below the rotary table and/or below the arms thereof and thus below the tool. The tool is accordingly brought, using the rotary table, into the shooting position, so that the stationary lifting device can act from below the tool.

As mentioned previously, the shooting plate together with a sand store adjusted to the respective tool is provided to the tool. Thus it is of further advantage if a shooting cap, which is filled with core sand, fits the respective tool and comprises the adjusted shooting plate with the sand store, is assigned to the tool, in front of or in the shooting station for the purpose of docking and subsequent shooting. This assignment preferably takes place in the shooting station so that the shooting process can take place immediately after the docking of the shooting head.

The respective shooting cap could be fed linearly to the shooting station. In a particularly advantageous manner, especially with respect to reducing the required workspace, the shooting cap is fed using an additional rotary table to the respective tool in the shooting station. Thereby the rotary table carrying the tools and the rotary table carrying the shooting cap co-rotate so that in a corresponding arrangement of both the rotary tables, the conveying directions of the tools and the shooting caps are directed opposite to one another in the shooting station.

Even the rotary table carrying the shooting caps is designed in the sense of a carousel with the arms carrying the shooting caps. According to the number of the tools, for example six different tools, a corresponding number of shooting caps is provided, thus six shooting caps with a shooting plate and sand store. The arms carrying the shooting caps extend outwards in a star-shaped manner wherein the rotary table is equipped according to the number of the different tools with a corresponding number of different shooting caps.

By rotating the rotary table the shooting caps can be brought one after the other into a filling station and from the filling station into the shooting station. In the filling station a preferably stationary sand bunker is provided using which the sand stores of the shooting caps are filled with a predeterminable quantity of core sand. The stationary sand bunker is thus used as a sand reservoir out of which the sand stores/shooting caps can be filled individually.

A shooting cap changing station is provided between the shooting station and the filling station for the purpose of additional automation of the device in question. There the shooting caps to be exchanged are transferred to a shooting cap transfer device. The shooting caps to be taken in exchange can be removed from the shooting cap transfer device, namely corresponding to the position of the rotary table carrying the shooting caps. The shooting caps can thus be exchanged one after the other or even individually.

In an additionally advantageous manner the shooting cap transfer device comprises two conveyor belts, which together form a linear conveyor. At least one manipulator is assigned to the linear conveyor, wherein said manipulator generates the transfer of the shooting caps from the shooting cap transfer device to the rotary table or from the rotary table to the shooting cap transfer device.

Preceding designs related to the rotary table for the shooting caps, wherein this rotary table is assigned to the shooting station. Between the shooting station and the removal station at least one additional treatment station is provided in the immediate surroundings of the rotary table carrying the tools. One or more gassing stations could be provided as the additional treatment station. These gassing stations are used for the further treatment of the already shot core, still located in the closed tool.

Every tool can have a combined gassing plate with integrated, upper ejection plate. Due to the shooting pattern of the shooting plate and/or due to the shape of the cores, each tool requires an individual combined gassing and ejection plate. For this purpose with every tool carrier a device is rotated simultaneously on the rotary table, wherein a combined gassing and ejection plate is installed on said device. After the shooting station, each combined gassing and ejection plate is moved over the tool and is pressed on the upper part of the tool using the stationary abutments when drifting the tool carrier into the gassing or purging station.

Thus in the gassing station a gassing device with gassing cap is provided, against which the closed tool with the closed core can be pressed. For this purpose a stationary lifting device could be provided, which is assigned stationarily to the respective gassing station. In any case, the tool can be pressed against the gassing cap by means of this lifting device so that the gassing process can take place.

Furthermore, it is of special significance that an exhaust device with a corresponding exhaust connection can be assigned to the gassing station.

The gassing device could additionally comprise very special ejection means for ejecting the core, preferably out of the upper half of the tool. The ejection means could in turn comprise an ejection plate, so as to enable a gentle ejection of the work piece when the tool is opened.

One or more purging stations corresponding to the gassing stations can be provided as the additional treatment station. Combined gassing/purging stations are likewise feasible. The purging station could in turn comprise an exhaust device with exhaust connection corresponding to the provisions in the gassing stations.

With respect to a fully automatic operation, it is additionally advantageous if a tool changing station is provided preferably between the shooting station and the removal station. Such a tool changing station could be combined with a gassing/purging station. It is also feasible that the tools, just as in the case of the shooting caps and/or the shooting cap change, are fed using an additional rotary table to the rotary table carrying and rotating the tools and/or are discharged from there.

Within the scope of a particularly simple design, in the tool changing station, the tools to be exchanged can be transferred to a tool transfer device and the tools to be taken in exchange can be removed from the tool transfer device. Thus the tool transfer device can be a linear conveyor, which comprises two conveyor belts and at least one manipulator—as in the case of the shooting caps. The tools given out in exchange can be fed to a separate cleaning device or a store and/or storeroom. Alternatively a complete exchange of all the tools can also be considered. Cleaned and/or new tools are conveyed to the corresponding station to be taken in exchange.

Between the removal station and the shooting station, an additional treatment station could be provided, namely one or more cleaning stations for cleaning the tool. Concretely, the cleaning station could comprise a blow-out device for blowing out the opened tool and also an injecting device for injecting the inner surfaces of the tool with releasing agents.

It is possible to arrange several above-described processing stations according to requirements. The number of the tools and shooting caps is predetermined according to the requirements of individual cores with respect to the core packet to be packeted.

There are various alternatives to advantageously design and improve the teaching of the present invention. For this purpose, reference must be made firstly to the claims and secondly to the following explanation of a preferred embodiment of the invention based on the drawings. Generally preferred designs and embodiments of the teaching are also explained in conjunction with the explanation of the preferred embodiment of the invention based on the drawings.

### BRIEF DESCRIPTION OF THE DRAWINGS

FIG. 1 illustrates schematically the top view of an embodiment of an apparatus according to the invention for producing core packets, the apparatus comprising a shooting station and several different processing stations,

FIG. 2 illustrates in detail a schematic side view of the interaction of two rotary tables with tools and shooting caps at the shooting station, which comprises a stationary shooting head and also a stationary lifting device, and

FIG. 3 illustrates in detail a schematic side view of a gassing station as a special treatment station.

### DETAILED DESCRIPTION OF THE PREFERRED EMBODIMENTS

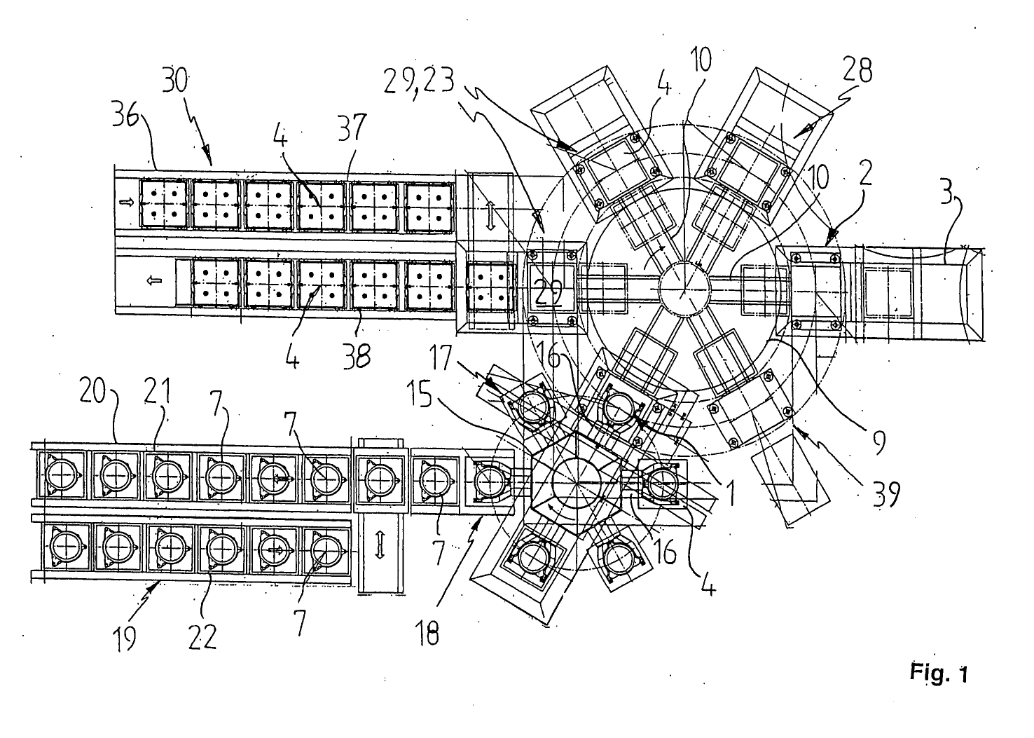

FIG. 1 illustrates an apparatus for producing core packets, which may be used in turn for casting engine blocks and cylinder heads. The apparatus comprises a shooting station 1, in which the individual cores are shot. Furthermore, the apparatus comprises a removal station 2, in which the shot cores are removed and are transferred for packet assembly to an assembly line 3 attached there. In the shooting station 1, a shooting cap 7 comprising a sand store 5 and a shooting plate 6 is associated together with a shooting head 8 to a tool 4, which is a two-part tool in the illustrated embodiment.

According to the invention, a rotary table 9 is provided, which carries several tools 4 for shooting different cores. By rotating the rotary table 9 the tools 4 are brought one after the other to the shooting station 1 and from the shooting station 1 together with the shot cores to the removal station 2.

It can also be seen in FIG. 1 that the rotary table 9 carries six tools 4 altogether, which are arranged equidistantly from one another. Finally, the rotary table 9 is equipped in the sense of a carousel with arms 10 carrying the tools 4, wherein the arms 10 extend outwardly in a star-shaped manner.

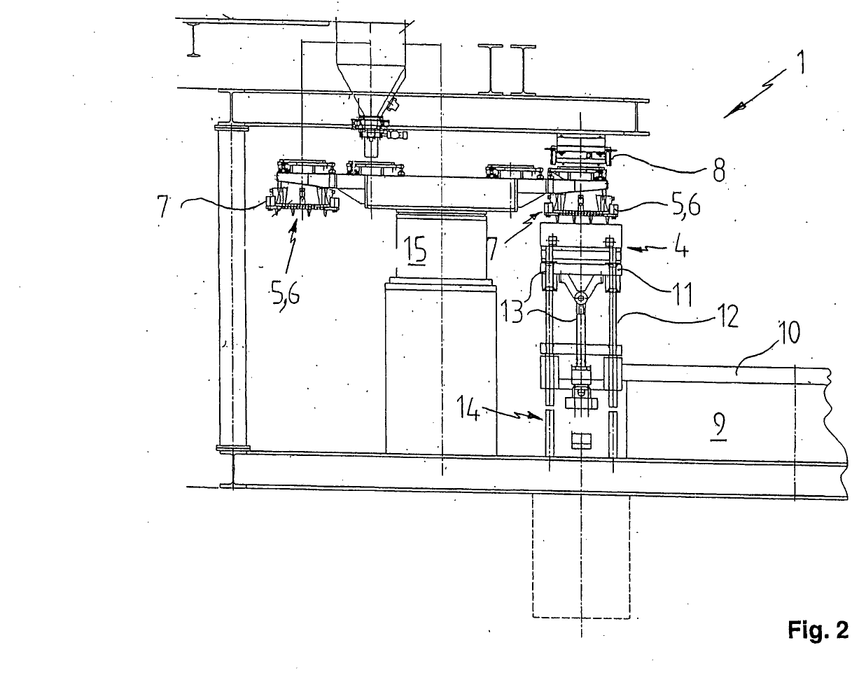

It can be seen in FIG. 2, which illustrates the shooting station 1, that the tools 4 together with the tool carriers 11 and the frames 12 holding the tool carriers 11 are arranged on the rotary table 9. For opening the tool 4, lifting devices 13 are thereby provided, which are assigned directly to the tool 4 and/or to the tool carrier 11.

FIG. 2 further illustrates that the shooting head 8 is stationarily arranged at the shooting station 1, wherein the tool 4 with the shooting plate 6 and the sand store 5 can be pressed against the shooting head 8. The sand store 5 and the shooting plate 6 together form the shooting cap 7. FIG. 2 also shows that an additional lifting device 14 is stationarily arranged below the rotary table 9 and/or below arms 10 thereof and thus also below the tool 4 in the shooting station 1. Both the lifting devices 13, 14 can operate hydraulically or pneumatically.

FIG. 1 and 2 together illustrate that a shooting cap 7, which is filled with core sand and fits the respective tool 4 is assigned to the tool 4 at the shooting station 1 for the purpose of docking and subsequent shooting. The shooting cap 7—together with the sand store 5 and the shooting plate 6—is fed using an additional rotary table 15 to the tool 4. According to the illustration in FIG. 1, both the rotary tables 9, 15 are associated in such a way that the rotary table 9 carrying the tools 4 and the rotary table 15 carrying the shooting caps 7 co-rotate, so that the conveying direction of the tools 4 and the shooting caps 7 are directed opposite to one another in the shooting station 1.

The rotary table 15 carrying the shooting caps 7 is also designed in the sense of a carousel with arms 16 carrying the shooting caps, wherein the arms 16 extend outwards in a star-shaped manner.

Furthermore, it should be noted that the rotary table 15 is equipped according to the number of the different tools 4 with a corresponding number of shooting caps 7. By rotating the rotary table 15, the shooting caps 7 are brought one after the other into a filling station 17, which is upstream of the shooting station 1. From the filling station 17 the shooting caps 7 are rotated into the shooting station 1.

The filling station 17 indicated in FIG. 1 comprises a stationary sand bunker, which cannot be seen in FIG. 1. FIG. 1 further shows that between the shooting station 1 and the filling station 17—with respect to the arrangement of the rotary table 15 carrying the shooting caps 7—a shooting cap changing station 18 is provided. In the shooting cap changing station 18 the shooting caps 7 to be given out in exchange are transferred to a shooting cap transfer device 19 and the shooting caps 7 to be taken in exchange are removed from the shooting cap transfer device 19, and arrive from there into the filling station 17 and finally into the shooting station 1 for the purpose of docking on the tool 4.

The shooting cap transfer device 19 comprises a linear conveyor 20 having two conveyor belts 21, 22 and a manipulator, which is not illustrated in the figure. The conveyor belt 22 is used for the supply of new shooting caps 7 and the conveyor belt 21 is used for transporting away the shooting caps 7, which are to be given out in exchange and/or cleaned.

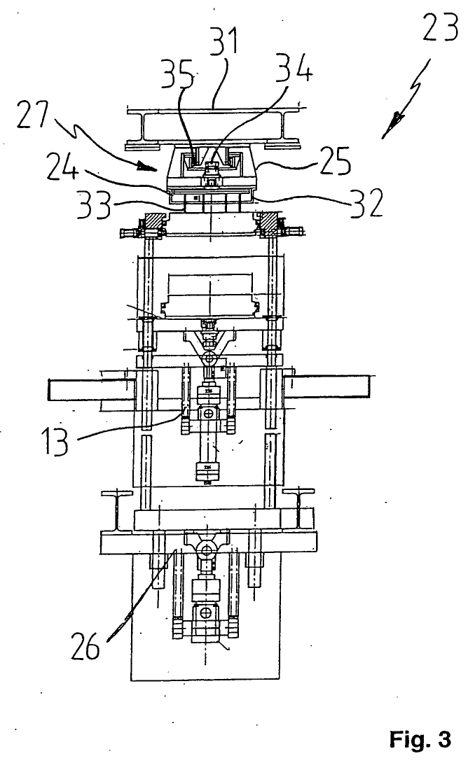

FIG. 1 further shows that between the shooting station 1 and the removal station 2 an additional treatment station is provided, namely a gassing station 23. Such a gassing station 23 is illustrated in detail in FIG. 3 within the scope of a schematic side view. The gassing station can comprise a preparation device, namely for the gassing air and/or purging air, which is prepared using an activator, catalyst and the like.

Specifically, in the illustration in FIG. 1, gassing stations 23, 29 and two purging stations 23, 28 are provided. The tool changing station 29 is also simultaneously used as a gassing station. This is described later in more detail.

According to the illustration in FIG. 3, the gassing station 23 comprises a stationary abutment 31 and a mobile device 27 for each tool carrier, said mobile device comprising a docked combined gassing and ejection plate 32. The ejector is indicated by the reference numeral 33. Furthermore, the ejection cylinder 34 and also the conductor rail 35 are illustrated in FIG. 3.

Tool-specific combined gassing and ejection plates 32 are docked on the gassing device 25. These gassing and ejection plates are moved after the shooting station over the tool and pressed against the abutment 31 and/or the upper part of the tool by lifting the complete tool carrier using the lifting device 26. The abutment 31 is provided with one or more connections using which the gassing air or purge air is fed into the combined gassing and ejection plate 32.

The gassing device 24 and/or the tool changing station 29 comprising the gassing station further contains ejection means 27, namely a tool-specific ejection plate 32 and/or an ejector 33 for ejecting the cores from the upper part of the tool 4 and/or for cleaning the shooting holes. This ejection plate is a fixed component of the combined upper gassing and ejection plate 32.

The ejecting means are activated, if required, for leveling the shooting positions after the shooting and before the gassing and in the core removal station 2 for ejecting the cores. The gassing station can also be used as the purging station if corresponding molding materials are used. This includes a preparation device for the gassing/purging air prepared using an activator or a catalyst.

One or two purging stations 28 are attached to the tool changing station/gassing station 29. The purging station 28 also comprises an exhaust device with a corresponding exhaust connection, which is not illustrated in the figures.

As mentioned previously, it is also possible to design one of the gassing stations 23 as a combined gassing station and tool changing station. Thus a tool changing station 29 is provided between the shooting station 1 and the removal station 2, said tool changing station being activated only if necessary. Otherwise the tool changing station 29 operates as the gassing station 23.

With respect to the tool changing station 29, it can be seen in FIG. 1 that the tools 4 to be exchanged there are transferred to a tool transfer device 30 and the tools 4 to be taken in exchange are removed from the tool transfer device 30. As in the case of the shooting cap transfer device 19, the tool transfer device 30 also comprises a linear conveyor 31 having two conveyor belts 32, 33. The manipulator provided there is not illustrated in FIG. 1.

FIG. 1 finally illustrates an additional treatment station, namely between the removal station 2 and the shooting station 1. There a cleaning station 34 is provided for cleaning the opened tool. This cleaning station 34 comprises a blow-out device for blowing-out the opened tool and an injecting device for injecting the inner surfaces of the tool, due to which a suitable releasing agent is provided for facilitating the ejection and/or removal of the core.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus for producing core packets which are adapted for use in casting engine blocks, cylinder heads, and the like, comprising
a shooting station in which individual cores are shot, said shooting station including a stationary shooting head,
a removal station in which shot cores are removed and transferred onto an assembly line for packet assembly,
a shooting cap which comprises a sand store and a shooting plate mounted for movement to an operative position at the shooting position, and
a plurality of tools for shooting cores arranged on a rotary table so that the tools can be serially moved to the shooting station so as to cooperate with the shooting head and the shooting cap for shooting cores, and from the shooting station with the shot cores to the removal station.

2. The apparatus according to claim 1, wherein at least six tools are arranged equidistantly from one another on the rotary table.

3. The apparatus according to claim 1, wherein the rotary table is configured in the manner of a carousel with radial arms carrying the tools.

4. The apparatus according to claim 2, wherein the tools are arranged together with tool carriers and frames holding the tool carriers on the rotary table.

5. The apparatus according to claim 4, wherein the tool carriers each comprise a lifting device used for opening the tool.

6. The apparatus according to claim 5, wherein a lower ejection device is assigned to each tool carrier and/or the lifting device.

7. The apparatus according to claim 1, further comprising a lifting device for lifting the tool which is located at the shooting station, and the associated shooting plate and the sand store, against the stationary shooting head.

8. The apparatus according to claim 7, wherein the lifting device is arranged stationarily below the rotary table and thus below the tool at the shooting station.

9. The apparatus according to claim 1, wherein the shooting cap comprises one of a plurality of shooting caps which are mounted on a second rotary table so as to permit each shooting cap to be selectively moved to a tool at the shooting station.

10. The apparatus according to claim 9, wherein the rotary table carrying the tools and the rotary table carrying the shooting caps are configured to co-rotate so that the conveying direction of the tools and shooting caps are directed opposite to one another at the shooting station.

11. The apparatus according to claim 10, wherein the rotary table supporting the shooting caps is equipped with a number of shooting caps corresponding to the number of the tools on the rotary table supporting the tools.

12. The apparatus according to claim 11 further comprising a filling station positioned along the path of the shooting caps upon rotation of their supporting table, and wherein the filling station comprises a stationary sand bunker.

13. The apparatus according to claim 12, further comprising a shooting cap changing station provided between the shooting station and the filling station.

14. The apparatus according to claim 13, wherein in the shooting cap changing station, the shooting caps to be given out in exchange can be transferred to a shooting cap transfer device and the shooting caps to be taken in exchange can be removed from the shooting cap transfer device.

15. The apparatus according to claim 14, wherein the shooting cap transfer device comprises a linear conveyor having at least one conveyor belt and at least one manipulator.

16. The apparatus according to claim 1, further comprising at least one additional treatment station positioned along the periphery of the rotary table between the shooting station and the removal station.

17. The apparatus according to claim 16, wherein the at least one additional treatment station comprises a gassing station, and wherein in the gassing station a gassing device with a gassing cap is provided, against which the closed tool with the shot core can be pressed.

18. The apparatus according to claim 16, wherein the at least one additional treatment station comprises a purging station, and wherein the purging station comprises an exhaust device with an exhaust connection.

19. The apparatus according to claim 1, further comprising a tool changing station provided along the periphery of the rotary table between the shooting station and the removal station.

20. The apparatus according to claim 19, wherein in the tool changing station the tools to be given out in exchange can be transferred to a tool transfer device and the tools to be taken in exchange can be removed from the tool transfer device.

21. The apparatus according to claim 20, wherein the tool transfer device comprises a linear conveyor having at least one conveyor belt and at least one manipulator.

22. The apparatus according to claim 21, wherein at least one additional treatment station is provided along the periphery of the rotary table between the removal station and the shooting station, said at least one additional treatment station comprising a blow-out device for blowing out the opened tool.
